(19) United States
(12) Patent Application Publication
(10) Pub. No.: US 2011/0312372 A1
(43) Pub. Date: Dec. 22, 2011

(54) MOBILE ELECTRONIC DEVICES

(75) Inventor: Hiroaki Miura, Kanagawa (JP)

(73) Assignee: KYOCERA CORPORATION, Kyoto (JP)

(21) Appl. No.: 13/203,429

(22) PCT Filed: Feb. 25, 2010
(86) PCT No.: PCT/JP2010/001283

§ 371 Date: Aug. 25, 2011

(30) Foreign Application Priority Data
Feb. 25, 2009 (JP) 2009-043235

(51) Int. Cl. H04W 88/02

(52) U.S. Cl. 455/550.1

(57) ABSTRACT

Provided are mobile electronic devices that have function manipulability that conforms more closely to the actual manner of use by users. mobile electronic device (1) is provided with a case, a rotary dial part (41) that is installed rotatably on said case, and a processing unit (70) that transitions to an indeterminate function state to await the completion of said rotation, when the beginning of rotation of the rotary dial part (41) is detected. When it is judged that said rotation is complete in said indeterminate function state, the processing unit (70) cancels said indeterminate function state and starts the corresponding function based on said rotation. When a prescribed event occurs in said indeterminate function state, a prescribed interrupt processing that corresponds to said prescribed event is performed prior to the start of the prescribed function that is based on said rotation.

### TECHNICAL FIELD

The present invention relates to a mobile electronic device having a rotary dial part.

### BACKGROUND ART

There is a demand for a more intuitive user interface in mobile electronic devices such as cellular telephones. For example, in a cellular telephone of a flip type having a hinge portion, a cellular telephone is known in which a hinge portion is provided with a rotary dial to be used for volume control and the like (e.g., refer to Patent Document 1).

In recent years, cellular telephone devices are made multifunctional by installing radio and television reception functions or a navigation function according to a navigation system, in addition to communication and call functions. Here, in cellular telephone devices, a communication/call standby screen is displayed as a top screen when a function such as a television reception function is not selected. When the user performs a predetermined operation, the standby screen transitions to a menu selection screen for selecting other functions, and the user selects a predetermined function on the menu selection screen, thereby making it possible to activate a desired function.

However, since many functions are listed on the menu selection screen, it is difficult for an inexperienced user to perform an operation smoothly, and such a user may hesitate to use a mobile electronic device in some cases.

A digital camera is known which performs menu selection by a rotary dial. A menu that assists in a mode change operation, such as changing from a normal photographing mode to a movie mode (recording moving images) or a continuous shooting mode (taking multiple still images in a short time) and the like, is assigned to be selectable to this rotary dial (e.g., refer to Patent Document 2).

[Patent Publication 1] Japanese Unexamined Patent Application, First Publication No. H06-90200

[Patent Publication 2] Japanese Unexamined Patent Application, First Publication No. 2001-245189

### DISCLOSURE OF THE INVENTION

### Problems To Be Solved By the Invention

A multiple-menu selecting system by a rotary dial such as that used in a digital camera is not currently employed in cellular telephone devices having more than one function.

Moreover, a cellular telephone device is different from a digital camera in that the cellular telephone device includes a special function (communication/call function) that is not included in a digital camera, and a communication/call standby screen as a top screen is displayed thereon.

Furthermore, there are also differences in terms of specifications such as in a case in which a predetermined application that is different from the communication/call function is operated, and the predetermined application is terminated thereafter, the communication/call standby screen is displayed.

Therefore, merely applying a technique as described in Patent Document 2 to the cellular telephone devices cause inconvenience in operating and usage. Mobile electronic devices having operability of functions that is more suitable for an actual usage modes of a user are anticipated.

The present invention is aimed at providing a mobile electronic device having function operability that is more suitable for actual usage modes of a user.

### Means For Solving the Problems

The present invention relates to a mobile electronic device comprising: a body; a rotary dial part that is rotatably attached to the body; and a processing unit that, in a case in which start of rotation of the rotary dial part is detected, enters into an undefined function state of waiting for the rotation to end, wherein the processing unit, in a case in which the rotation is determined to have ended in the undefined function state, exits the undefined function state and activates a corresponding function based on the rotation, and in a case in which a predetermined event occurs in the undefined function state, performs a predetermined interruption process corresponding to the predetermined event before activating a predetermined function based on the rotation.

The present invention relates to a mobile electronic device comprising: a body; a rotary dial part that is rotatably attached to the body; and a processing unit that: in a case in which start of rotation of the rotary dial part is detected, enters into an undefined function state of waiting for the rotation to end; and in a case in which the rotation is determined to have ended thereafter, activates a corresponding function based on the rotation, wherein the processing unit, when a predetermined event occurs in the undefined function state before the rotation of the rotary dial part is determined to have ended, performs a predetermined interruption process based on the event after the rotation is determined to have ended, and activates a predetermined function based on the rotation after completion of the interruption process.

Moreover, it is preferable that the mobile electronic device according to claim 1, wherein the processing unit determines that the rotation has ended by at least a predetermined time period elapsing after the rotation of the rotary dial part stops.

Furthermore, it is preferable that the mobile electronic device according to claim 1, wherein the processing unit, before activating the predetermined function, determines whether or not activation is possible and activates the predetermined function only if activation is determined to be possible.

In addition, it is preferable that the mobile electronic device according to claim 1, wherein the processing unit activates a function corresponding to an amount of rotation from a position at which the rotation of the rotary dial part begins to a position at which the rotation stops as the predetermined function.

Moreover, it is preferable that the mobile electronic device according to claim 1 further comprising a radio communication unit that performs radio communication with an external device, wherein the event includes initiation of radio communication by the radio communication unit.

Furthermore, it is preferable that the mobile electronic device according to claim 6, wherein the event is an incoming call.

The present invention relates to an application start control method for a mobile electronic device with a rotary dial part rotatably attached thereto, the method comprising: a detection step of detecting rotation of the rotary dial part; an end determination step of determining, after detection of beginning of the rotation, that the rotation has ended; a first processing step of entering an undefined function state after detection of the beginning of the rotation until determination that the rotation has ended; a second processing step, upon determination that the rotation in the undefined function state has ended, of exiting the undefined function state and activating a predetermined function specified according to the rotation; and a third processing step, in a case in which a predetermined event occurs in the undefined function state, of performing a predetermined interruption process corresponding to the predetermined event before activating the predetermined function.

### Effects of the Invention

According to the present invention, a mobile electronic device having function operability that is more suitable for actual usage modes of a user can be provided.

### BRIEF DESCRIPTION OF THE DRAWINGS

FIG. 1 is a diagram illustrating an appearance of a cellular telephone device 1 of an embodiment of the present invention;

FIG. 2 is a diagram illustrating an appearance of the cellular telephone device 1 shown in FIG. 1 in a closed state, viewed from a display unit side body 3;

FIG. 3 is a diagram illustrating an appearance of the cellular telephone device 1 shown in FIG. 1 in a closed state, viewed from an operation unit side body 2;

FIG. 4 is an enlarged view of a vicinity of a rotary dial part 41 of the cellular telephone device 1 shown in FIG. 1;

FIG. 5 is a diagram illustrating functions of the rotary dial part 41;

FIG. 6 is a functional block diagram illustrating functions of the cellular telephone device 1 shown in FIG. 1;

FIG. 7 is a flow chart showing a first half of an example regarding operation of a processing unit 70 of the cellular telephone device 1 shown in FIG. 1;

FIG. 8 is a flow chart showing a latter half of the example regarding operation of the processing unit 70 of the cellular telephone device 1 shown in FIG. 1; and

FIG. 9 is a diagram sequentially illustrating changes in display of a display 21 of the cellular telephone device 1 of the example shown in FIGS. 7 and 8.

### EXPLANATION OF REFERENCE NUMERALS

1 cellular telephone device (mobile electronic device)

2 operation unit side body (body)

3 display unit side body (body)

41 rotary dial part

60 communication unit (radio communication unit)

70 processing unit

201 rotation detecting unit

202 application activation processing unit

203 interruption detection unit

204 interruption processing unit

205 undefined function state determination unit

206 application activation determination unit

### PREFERRED MODE FOR CARRYING OUT THE INVENTION

A cellular telephone device 1 as an embodiment of a mobile electronic device of the present invention is described hereinafter.

It should be noted that, although a cellular telephone device is described hereinafter as an embodiment, the present invention is not limited thereto and may be PHS (Personal Handyphone System), a PDA (Personal Digital Assistant), a portable navigation apparatus, a laptop computer, or the like.

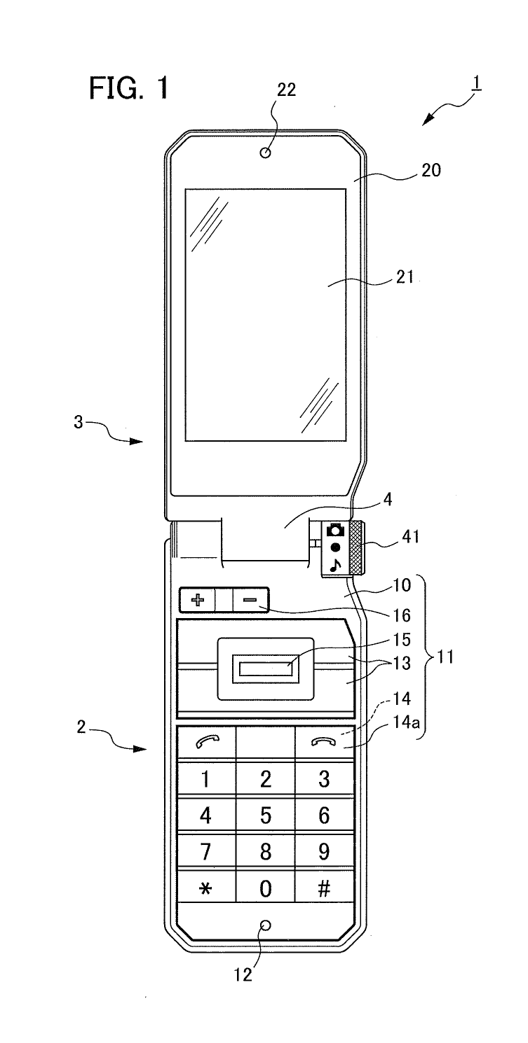

As shown in FIG. 1, the cellular telephone device 1 of the present embodiment is configured to include an operation unit side body (body) 2 and a display unit side body (body) 3. The operation unit side body 2 is configured to include on a front face 10 thereof an operation key set 11 and a microphone 12 into which speech produced by a user of the cellular telephone device 1 is input.

The operation key set 11 includes feature setting operation buttons 13, input operation buttons 14, a selection operation button 15, and a control button 16. The feature setting operation buttons 13 are for operating various settings and various features such as a telephone number directory feature and an email feature. The input operation buttons 14 are for inputting digits of a telephone number and text characters for email. The selection operation button 15 is for performing selections, scrolling and the like in various operations. The control button 16 is for performing volume control and the like.

In addition, the display unit side body 3 is configured to include, on a front face portion 20, a display 21 for displaying a variety of information, and a sound output unit 22 for outputting sound of the other party in a conversation.

An upper end portion of the operation unit side body 2 and a lower end portion of the display unit side body 3 are connected via a hinge mechanism 4. The cellular telephone device 1 can be in a state where the operation unit side body 2 and the display unit side body 3 are apart from each other (opened state), and in a state where the operation unit side body 2 and the display unit side body 3 are in contact with each other (closed state), as the operation unit side body 2 and the display unit side body 3, connected via the hinge mechanism 4, pivot with respect to each other.

It should be noted that, although FIG. 1 shows a so-called flip type cellular telephone, the present invention is not particularly limited thereto. The cellular telephone device may be, for example, a slider type in which one of the bodies slides to one direction in a state in which the operation unit side body 2 and the display part side body 3 are mutually superimposed; a rotating (turning) type in which one of the bodies is rotated around an axis line in the direction in which the operation unit side body 2 and the display part side body 3 overlap; and a type (straight type) in which the operation unit side body 2 and the display part side body 3 are disposed in one body without having the connecting portion.

In addition, a rotary dial part 41 is provided at a position where the hinge mechanism 4 is formed in the cellular telephone device 1. The rotary dial part 41 is attached to the bodies 2 and 3 so as to be rotatable in a predetermined direction. Operations and functions of the rotary dial part 41 are described later.

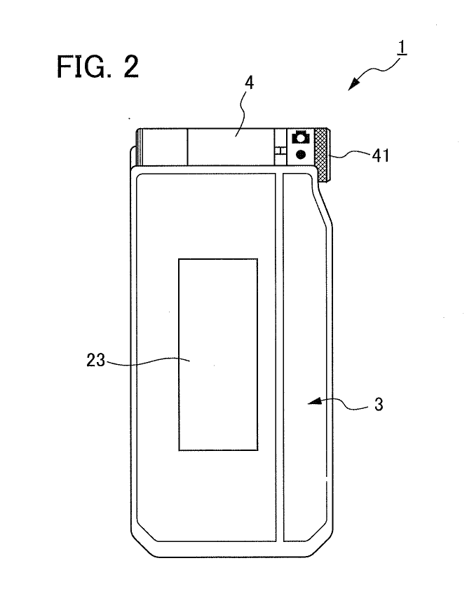

Furthermore, as shown in FIG. 2, the display unit side body 3 is provided with a sub display 23 that displays predetermined information, on an opposite side (reverse side) to the front face portion 20 where the display 21 is disposed.

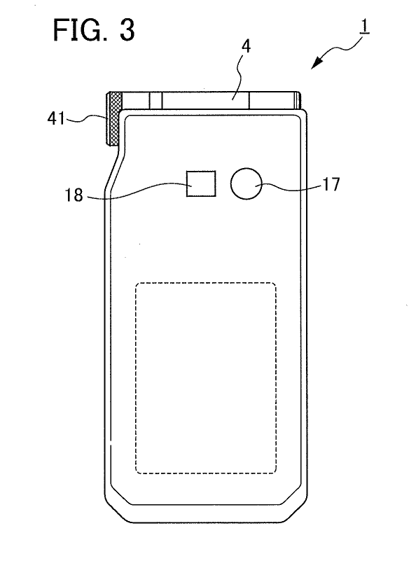

Moreover, as shown in FIG. 3, an imaging part 17 configured with a CCD (Charge Coupled Device) camera for taking an image of a subject and the like, and a light-emitting part 18 that outputs a certain amount of light are provided in the operation unit side body 2, on an opposite side (reverse side) to the front face part 10 where the operation key set 11 is disposed.

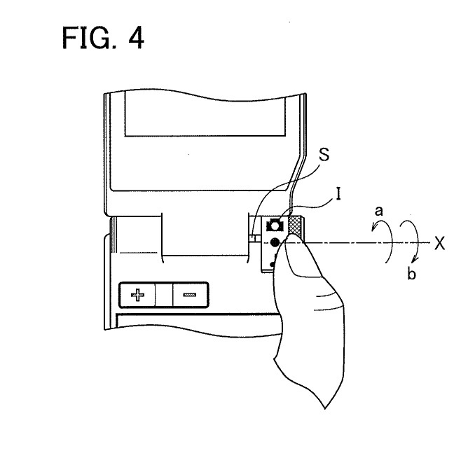

Next, operations and functions of the rotary dial part 41 are described. The rotary dial part 41 is attached to the bodies 2 and 3 so as to be rotatable in predetermined directions (direction a (a first direction orthogonal to a rotational axis of the hinge mechanism 4) and direction b (a second direction orthogonal to the rotational axis of the hinge mechanism 4) in FIG. 4) by a user's finger, about a rotational axis X of the hinge mechanism 4.

It should be noted that the rotary dial part 41 is not limited to the configuration shown in FIG. 4 and can be of any configuration in which the rotary dial part 41 is rotatable by a user's operation, such as a configuration in which the rotary dial part 41 is rotatable in predetermined directions about an axis orthogonal to the rotational axis (hinge axis) X.

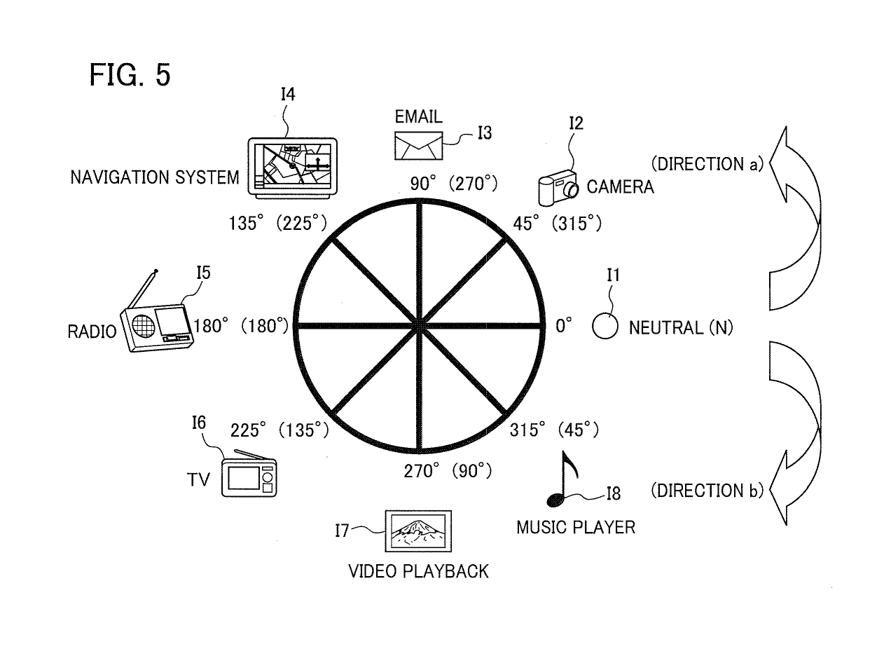

A plurality of icons I (I1 to I7) is allocated on the rotary dial part 41 at predetermined intervals in a rotation direction. As shown in FIG. 5, for example, the icons I are represented by images that are easy for the user to understand, as signs used in selecting an application.

Here, user operations of the rotary dial part 41 are briefly described. The user moves an icon I corresponding to a desired application to a selection position S (sign) indicated by a mark or the like on an outer surface of a case for the hinge mechanism 4, using the icons I as hints. Then the cellular telephone device 1 activates an application corresponding to the icon I resting at the selection position S. The rotary dial part 41 thus allows selection of menus for achieving various functions by the operation of the physical rotary dial.

In addition, the rotary dial part 41 allows selection of menus for achieving various functions by the operation of the physical rotary dial.

For example, as shown in FIG. 5, the rotary dial part 41 is rotated 45 degrees in the direction a (315 degrees in the direction b) relative to the non-operation state (neutral (N)) by the user's rotation operation, thereby activating a camera function of the imaging part 17. The rotary dial part 41 is rotated 90 degrees in the direction a (270 degrees in the direction b), thereby activating an email application.

The rotary dial part 41 is rotated 135 degrees in the direction a (225 degrees in the direction b) relative to the non-operation state (neutral (N)), thereby activating a navigation system application. The rotary dial part 41 is rotated 180 degrees in the direction a (180 degrees in the direction b), thereby activating a radio function.

The rotary dial part 41 is rotated 225 degrees in the direction a (135 degrees in the direction b) relative to the non-operation state (neutral (N)), thereby activating a TV function. The rotary dial part 41 is rotated 270 degrees in the direction a (90 degrees in the direction b), thereby activating a video playback application. The rotary dial part 41 is rotated 315 degrees in the direction a (45 degrees in the direction b), thereby activating a music player, which is an audio playback application.

It should be noted that the abovementioned menus allocated to rotation angles of the rotary dial part 41 are examples, and the present invention is not limited thereto. For example, a configuration may be employed in which a menu that is frequently used by the user can be registered. In addition, a configuration may be employed in which a desired Web address is registered in advance, and when the Web address is selected by the rotary dial part 41, a Web browser is activated to enable browsing of a Web page of the Web address. Furthermore, the number of functions included in the menu is not limited either to the aforementioned number (seven).

In addition, the user can directly activate the various functions assigned to the rotary dial part 41 under certain conditions, by directly operating the rotary dial part 41. Accordingly, it is not necessary to go through the main menu as in conventional cases, and it is possible for the user to easily activate a desired application.

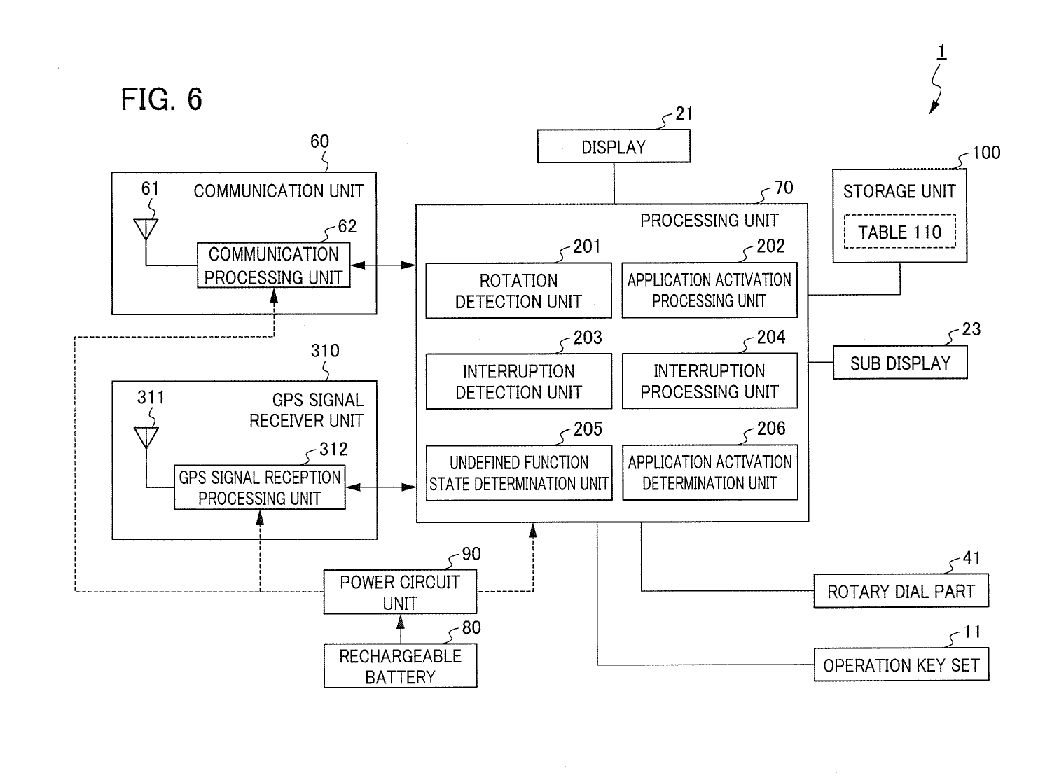

Next, various functions of the cellular telephone device 1 are described in detail. FIG. 6 is a functional block diagram illustrating functions of the cellular telephone device shown in FIG. 1. As shown in FIG. 6, the cellular telephone device 1 includes a display 21 that is not exposed to the outside in the closed state and a sub display 23 that is exposed to the outside in the closed state. The cellular telephone device 1 is further provided with: the operation key set 11 including keys used for user operation; the rotary dial part 41 that is rotated by the user operation; a communication unit (radio communication unit) 60 that performs communications with external terminals; a GPS signal receiver unit (radio communication unit) 310 that receives a GPS signal from GPS satellites; the processing unit 70 that performs predetermined processing; the rechargeable battery 80 having a predetermined capacity; a power supply circuit unit 90, which converts a power supply voltage supplied from the rechargeable battery 80 into a predetermined voltage, and which feeds the converted voltage to the communication unit 60, the processing unit 70 and the like; and a memory unit 100 that has a table 110.

The communication unit 60 is provided with: the main antenna 61 that performs communications with an external device at a predetermined usage frequency band; and the communication processing unit 62 that performs signal processing such as modulation processing or demodulation processing.

The main antenna 61 performs radio communication with the external device (base station) at a predetermined usage frequency band (e.g., 800 MHz). It should be noted that, although the predetermined usage frequency band is set to 800 MHz in the present embodiment, other frequency bands can also be used. Moreover, in addition to the predetermined usage frequency band, the main antenna 61 may have a so-called dual band adaptive configuration that is adaptive to a second usage frequency band (e.g., 2 GHz), and furthermore, it may have a multiple band adaptive configuration that is adaptive to a third usage frequency band.

The communication processing unit 62 applies demodulation processing to signals received by the main antenna 61, and supplies the processed signals to the processing unit 70. In addition, the communication processing unit 62 applies modulation processing to the signals supplied from the processing unit 70, and transmits the signals to the external device (base station) through the main antenna 61.

The GPS signal receiver unit 310 includes a GPS antenna 311 that receives a GPS signal from the GPS satellites by radio communication, and a GPS signal reception processing unit 312 that performs signal processing such as demodulation processing.

The GPS antenna 311 is an antenna for radio communication with respect to the GPS satellites, and receives a GPS signal transmitted from the GPS satellites.

The GPS signal receiving processing unit 312 applies demodulation processing to the GPS signal received by the GPS antenna 311, and supplies the processed signal to the processing unit 70.

The power supply circuit unit 90 transforms a power supply voltage, which is supplied from the rechargeable battery 80, to a predetermined voltage value, and supplies the transformed voltage to the communication unit 60, the GPS signal receiver unit 310, the processing unit 70 and the like.

The memory unit 100 stores a number of programs that are executed by the processing unit 70, and parameters, various tables and the like.

More specifically, the memory unit 100 includes working memory such as VRAM (Video RAM) and is used for arithmetic processing by the processing unit 70. The memory unit 100 stores: a number of application programs, of which activation, termination, interruption and the like are performed by the control unit 70; parameters that are used by the plurality of applications; an OS (Operating System) program for operating the plurality of application programs.

In addition, the memory unit 100 stores the table 110. The table 110 may include information concerning corresponding relationships between the rotation amount detected by a rotation detecting unit 201 (described later) and plural applications (refer to FIG. 5), and information for determination of whether or not activation is possible, to be used in determination by an application activation determination unit 206 (described later).

The plurality of application programs include application programs for applications provided by the cellular telephone device 1, such as a standard application, a video playback application, a camera application, an email application, a TV application, a radio application, a navigation system application, a music player, and the like.

The processing unit 70 is configured to include a central processing unit (CPU) and the like, and controls the entire cellular telephone device 1. The processing unit 70 performs, for example, activation processing for various functions (particularly the applications) in accordance with various types of information relating to rotation of the rotary dial part 41 (rotation amount, rotation position, presence or absence of rotation, start of rotation, end of rotation and the like; hereinafter also referred to as “rotation information”) that is supplied from the rotary dial part 41. The processing unit 70 also performs activation processing for various functions not related to the rotation of the rotary dial part 41 (such as a call function).

Here, a configuration and operations of the processing unit 70 are described. The processing unit 70 detects the rotation information of the rotary dial part 41 and performs control to activate a predetermined application corresponding to the rotation information thus detected. The processing unit 70 performs control to display a display screen corresponding to the predetermined application thus activated, on the display 21 and the like, as necessary.

It should be noted that, although the amount of change of the angle of the rotary dial part 41 is detected as rotation amount with regard to the rotation information in the present embodiment, it is not limited thereto, and any change depending on the rotation of the rotary dial part 41 may be detected. For example, a change of resistivity may be detected as the rotation amount. Alternatively, a rotation position of the rotary dial part 41 may be detected as the rotation information and control according to the rotation position thus detected can be performed.

The control unit 70 refers to the table 110 for the application correspondence relationship in the memory unit 100 every time the rotary dial part 41 is rotated, and identifies an application corresponding to the rotation information such as rotation amount. The table 110 includes a plurality of tables, and the control unit 70 refers to different tables according to the application currently selected.

When the power supply of the cellular telephone device 1 is turned on, the processing unit 70 firstly starts up an OS program, and activates the standard application program under the control of the OS, thereby performing control to display a standby screen (idle screen, wall paper or desktop) on the display 21. The standby screen is designed to notify a user of: a state of standby for initiation of radio communication; or a state of standby waiting for a request to activate an application other than the standard application displaying the standby screen.

Subsequently, every time an application to be activated is initiated, the processing unit 70 performs control to activate a new application program by terminating or interrupting the standard application program under the control of the OS. By this processing, the processing unit 70 performs control to display a screen based on the newly activated application in place of the standby screen on the display 21.

It should be noted that also in a case in which an application program that has been activated is an application program other than the standard application program, the processing unit 70 terminates or interrupts the application program that has been activated and activates a new application program. Then the processing unit 70 performs control to change the screen based on the application program previously activated to a screen based on the new application program.

The cellular telephone device 1 thus configured has a function, in a case in which interruption processing is initiated between the detection of a start of rotation of the rotary dial part 41 and activation of an application that is a target for activation, of performing the interruption processing in preference to activation of the application that is a target for activation.

Next, a configuration and operations of the processing unit 70 for realizing the function are described.

The processing unit 70 enters into an undefined function state of waiting for the rotation to end in a case in which the start of rotation of the rotary dial part is detected, and activates a corresponding function based on the rotation in a case in which the rotation is determined to have ended in the undefined function state. In addition, in a case in which a predetermined interruption event occurs in the undefined function state before the rotary dial part is determined to have ended, the processing unit 70 performs predetermined interruption processing based on the interruption event, and activates a predetermined function based on the rotation after completion of the interruption process.

For performing such processing, as shown in FIG. 6, the processing unit 70 is provided with: the rotation detection unit 201; an application activation processing unit 202; an interruption detection unit 203; an interruption processing unit 204; an undefined function state determination unit 205; and an application activation determination unit 206.

The rotation detection unit 201 detects rotation of the rotary dial part 41. Detection of rotation of the rotary dial part 41 includes detection of the rotation information relating to rotation of the rotary dial part 41 (rotation amount, rotation position, presence or absence of rotation, start of rotation, end of rotation, stoppage of rotation and the like) that is supplied from the rotary dial part 41. The rotation information thus detected by the rotation detection unit 201 is outputted to the application activation processing unit 202 and the like.

Based upon the rotation detected by the rotation detection unit 201, the application activation processing unit 202 determines and activates a predetermined application that is a target for activation among a plurality of applications. For example, the application activation processing unit 202 activates an application corresponding to a rotation amount between a position at which the rotation of the rotary dial part 41 begins and a position at which the rotation stops.

The interruption detection unit 203 detects an interruption event that has occurred. The interruption event may include an incoming call, an incoming email, an alarm ringing event, reception of map update information for the navigation system, or the like.

The interruption processing unit 204 performs predetermined interruption processing based on the interruption event detected by the interruption detection unit 203. The interruption processing may include activation of a call application in response to an incoming call, activation of an email application in response to an incoming email, activation of an alarm in response to the alarm ringing event, activation of the navigation system application in response to reception of the map update information and the like can be exemplified.

When the interruption event is detected by the interruption detection unit 203, the interruption processing unit 204 immediately performs interruption processing in a state or circumstance in which the interruption processing corresponding to the interruption event can be performed. On the other hand, in a state in which the interruption processing cannot be performed, the interruption processing unit 204 cancels the interruption processing or performs the interruption processing after it becomes possible to start the interruption processing.

The undefined function state determination unit 205 determines whether the current state is the undefined function state or not. The undefined function state is a state of waiting for rotation after detection of (beginning of) rotation of the rotary dial part 41 by the rotation detection unit 201. The undefined function state can be said to be a state in which a user is willing to activate, but actually has not yet activated, an application that is a target for activation.

The end of the undefined function state can be defined at a moment in which the rotary dial part 41 is positioned at an activation position or after a predetermined time period has elapsed since the rotary dial part 41 has been positioned at the activation position. The activation position is a position at which the rotary dial part 41 is positioned to activate the application that is a target for activation. The activation position is a position at which the icon I corresponding to the application that is a target for activation matches the selection position S.

Particularly, the end of the undefined function state is preferably defined as being after a predetermined time period has elapsed after the rotary dial part 41 has been positioned at the activation position. This configuration is for avoiding activation of applications that are not targets for activation, since generally, in a case of rotating the rotary dial part 41 in order to activate an application corresponding to any of the icons I1 to I7, the rotary dial part 41 may pass through the activation positions corresponding to applications that are not targets for activation. The predetermined time period can be appropriately set, for example, as 0.5 to 1 seconds.

The application activation determination unit 206 determines whether or not activation of the application that is a target for activation is possible. For example, in a state in which activation of the application that is a target for activation is possible or preferable, the application activation determination unit 206 determines that activation of the application that is a target for activation is possible. On the other hand, in a state or circumstance in which activation of the application that is a target for activation is impossible or not preferable, the application activation determination unit 206 determines that activation of the application that is a target for activation is impossible.

If the application activation determination unit 206 determines that activation of the application that is a target for activation is impossible, activation of the application may be interrupted, or may be performed after that a state or circumstance allows activation thereof, according to a state or circumstance of the cellular telephone device 1.

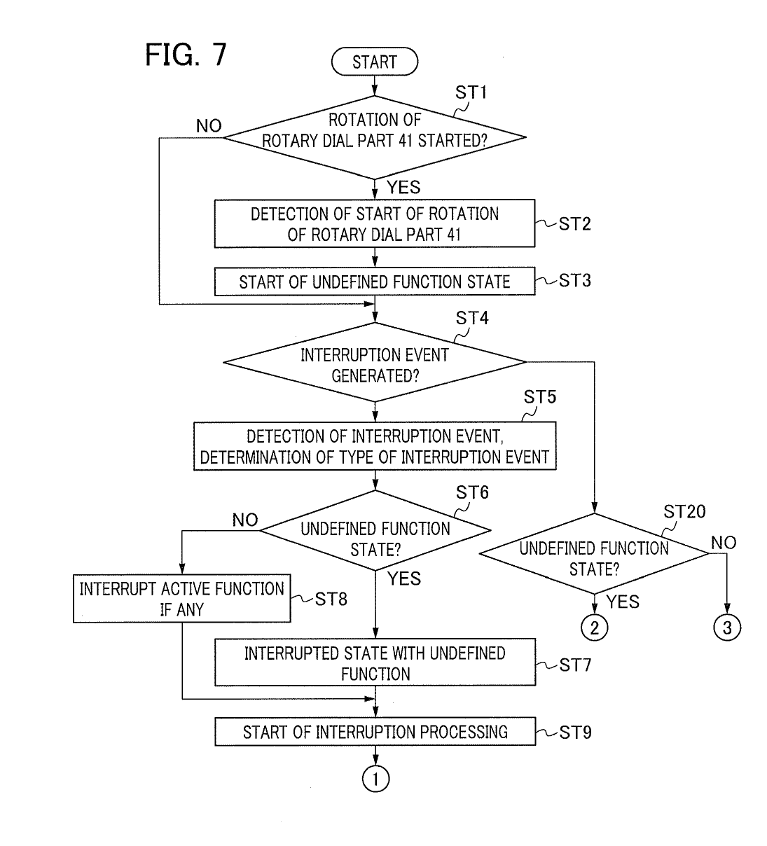

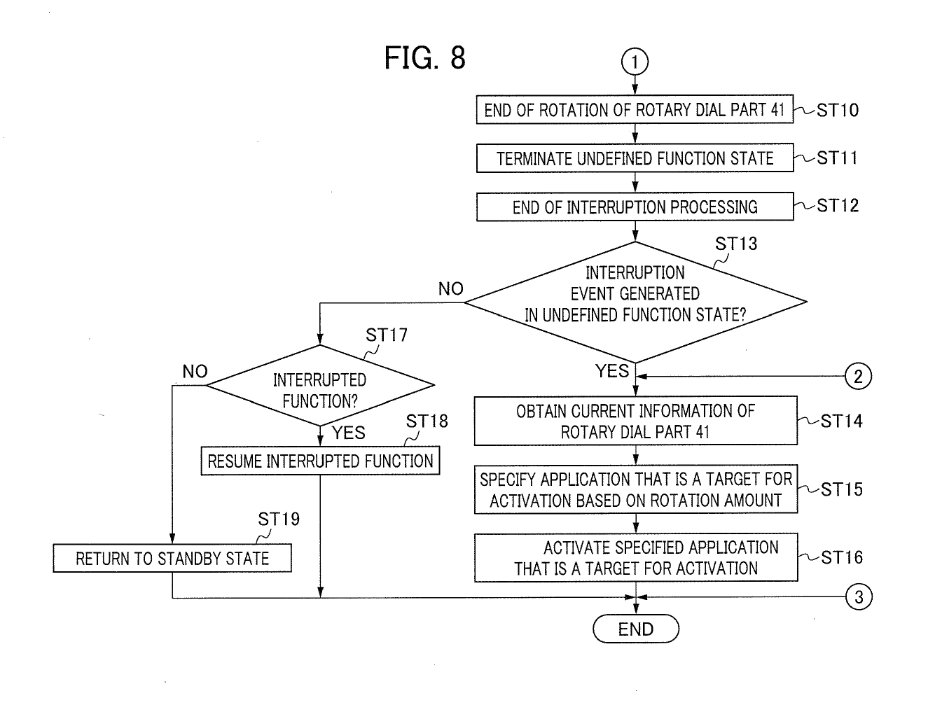

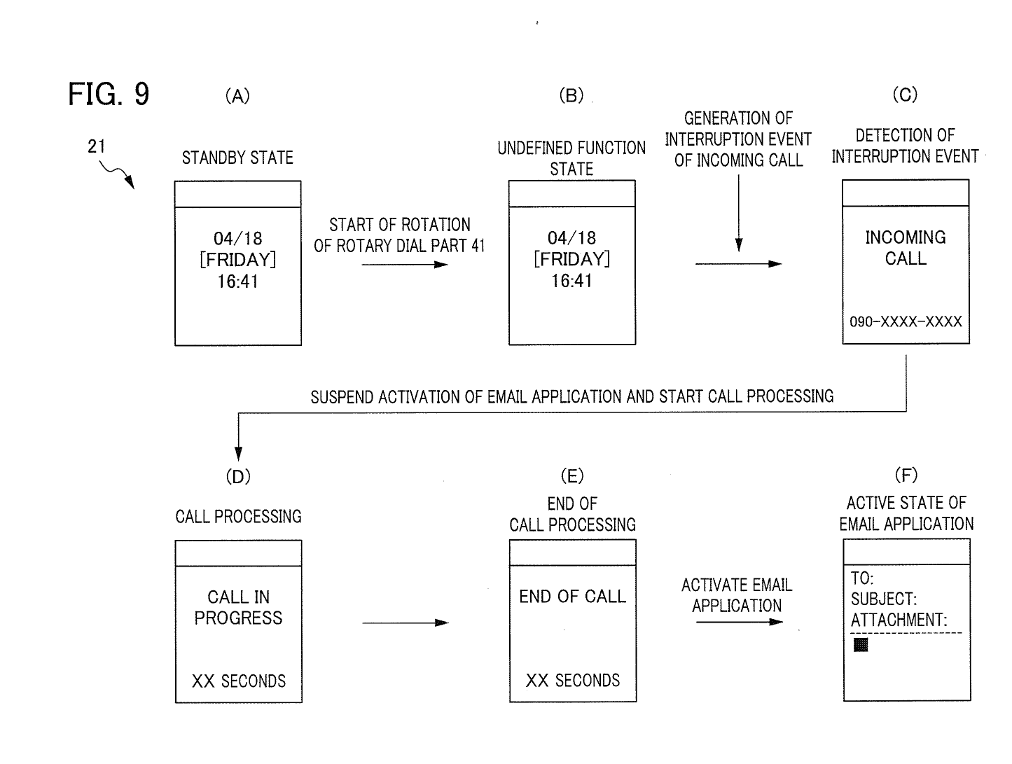

Next, specific operations of the processing unit 70 of the cellular telephone device 1 according to the present embodiment are described with reference to the flow charts shown in FIGS. 7 and 8 and changes in display of the display 21 shown in FIG. 9.

### EXAMPLE

The present example shows a case of receiving an incoming call for voice communication as an interruption event, while rotating the rotary dial part 41 in order to activate the email application (in other words, during an activation operation), in a standby state in which a standby application (standard application) is activated. The example is described hereinafter with reference to FIGS. 7 to 9.

In the present example, first, the cellular telephone device 1 is in a standby state and the display 21 displays the standby screen. In the standby screen, a current date, day and time are displayed (see (A) of FIG. 9).

In addition, in the present example, rotation of the rotary dial part 41 starts, so as to move the rotary dial part 41 to the activation position of the email application (a position at which the icon 13 matches the selection position S), thereby activating the email application. Furthermore, an incoming call as the interruption event is generated after the start of rotation of the rotary dial part 41 (after the start of the undefined function state) and before determination of end of the rotation.

As shown in FIG. 7, in Step ST1, the rotation detection unit 201 determines whether the rotation of the rotary dial part 41 has started or not. If the rotation of the rotary dial part 41 has started, the processing advances to Step ST2. On the other hand, if the rotation of the rotary dial part 41 has not started, the processing advances to Step ST4. In the present example, the rotation of the rotary dial part 41 has started and the processing advances to Step ST2.

In Step ST2, the rotation detection unit 201 detects the start of rotation of the rotary dial part 41. When the rotation detection unit 201 detects the start of rotation of the rotary dial part 41, the start of the undefined function state (see (B) of FIG. 9) is detected in Step ST3. Upon detection of the undefined function state, the rotation detection unit 201 stores a flag showing the undefined function state to the memory unit 100. Here, the display 21 keeps displaying the standby screen.

In Step ST4, the interruption detection unit 203 detects presence or absence of the interruption event. If generation of the interruption event is detected in the undefined function state (this state is referred to as “interrupted state with undefined function”), the rotation detection unit 201 stores a flag showing the “interrupted state with undefined function” in the memory unit 100. If the interruption event is generated (a determination of YES), the processing advances to Step ST5. If the interruption event is not generated (a determination of NO), the processing advances to Step ST20. In the present example, an incoming call is generated as the interruption event, and the processing advances to Step ST5.

In the present example, since an incoming call is generated as the interruption event, in Step ST5 the interruption detection unit 203 detects the incoming call and determines the type of the interruption event. Here, the display 21 switches the standby screen (see (B) of FIG. 9) to a screen showing an incoming call (see (C) of FIG. 9).

In Step ST6, the undefined function state determination unit 205 determines whether a current state is the undefined function state or not. If the current state is the undefined function state (a determination of YES), the processing advances to Step ST7. If the current state is not the undefined function state (determination of NO), the processing advances to Step ST8. As described above, in the present example, as the current state is the undefined function state, the undefined function state determination unit 205 determines the current state as the undefined function state (determination of YES) and the processing advances to Step ST7.

In the present example, as the interruption event is generated in the undefined function state in Step ST7, the current state is the “interrupted state with undefined function”.

In Step ST8, for example if the interruption event is generated in a defined function state with an application being activated, normal interruption processing is performed. For example, if there is any application (function) being active, the active function is interrupted.

In Step ST9, the interruption processing unit 204 starts interruption processing corresponding to the interruption event. In the present example, the interruption processing unit 204 performs application performing call processing for an incoming call (call application). Here, the display 21 switches the screen showing an incoming call (see (C) of FIG. 9) to a screen showing the call processing in progress (see (D) of FIG. 9). A user presses a predetermined call key or the like to make conversation possible, and then starts conversation.

As shown in FIG. 8, in Step ST10 the rotary dial part 41 is positioned at the activation position, as a result of the user rotation operation of the rotary dial part 41 during or after activation of the call application. The rotation of the rotary dial part 41 is thus terminated.

In Step ST11, the undefined function state is terminated and transitioned to the defined function state, after the rotary dial part 41 was positioned at the activation position or after a predetermined time period has elapsed after the rotary dial part 41 was positioned at the activation position. Here, the application activation processing unit 202 does not allow (disallows) activation of the application that is a target for activation. As a result, the application that is a target for activation is not activated in Step ST11.

In Step ST12, the interruption processing unit 204 terminates the interruption processing. In the present example, the interruption processing unit 204 terminates the call application at the end of conversation by the user. Here, the display 21 switches the screen showing a call in process (see (D) of FIG. 9) to a screen showing that call processing has ended (see (E) of FIG. 9).

The interruption processing may end before rotation of the rotary dial part 41 ends (before the undefined function state ends).

In Step ST13, the interruption detection unit 203 determines presence or absence of generation of the interruption event in the undefined function state, in other words presence or absence of the “interrupted state with undefined function”. Presence or absence of the “interrupted state with undefined function” can be determined by checking presence or absence of a flag showing the “interrupted state with undefined function” stored in the memory unit 100. If generation of the interruption event in the undefined function state is present (“interrupted state with undefined function”) (determination of YES), the processing advances to Step ST14. If generation of the interruption event in the undefined function state is not present (determination of NO), the processing advances to Step ST17. In the present example, generation of the interruption event in the undefined function state is present, and the processing advances to Step ST14.

In Step ST14, the rotation detection unit 201 obtains current information relating to the rotary dial part 41 (rotation amount, presence or absence of rotation and the like). In the present example, the rotary dial part 41 stops rotating and is positioned at the activation position of the email application.

In Step ST15, based upon the rotation amount and the like detected by the rotation detection unit 201, the application activation processing unit 202 determines the application that is a target for activation. In the present example, the application activation processing unit 202 determines the email application as the application that is a target for activation, based on the rotation amount of the rotary dial part 41.

In Step ST16, the application activation processing unit 202 activates the application that is a target for activation, which is determined in Step ST15. In the present example, the application activation processing unit 202 activates the email application. Here, the display 21 switches the screen showing the end of call processing (see (E) of FIG. 9) to an activation screen of email application (see (F) of FIG. 9).

Next, a description is given concerning flow in a case in which generation of the interruption event in the undefined function state is not present (determination of NO) in Step ST13.

If generation of the interruption event in the undefined function state is not present (determination of NO), in Step ST17, the application activation processing unit 202 determines presence or absence of a function interrupted by the interruption processing. If the function interrupted by the interruption processing is present (determination of YES), the processing advances to Step ST18. If the function interrupted by the interruption processing is not present (determination of NO), the processing advances to Step ST19.

If the function interrupted by the interruption processing is present (determination of YES), in Step ST18, the application activation processing unit 202 resumes an application to perform the function interrupted by the interruption processing. Thereafter, the processing is terminated.

If the function interrupted by the interruption processing is not present (determination of NO), in Step ST19, the application activation processing unit 202 activates the standby application (returns to the standby state). Thereafter, the processing is terminated.

Next, a description is given concerning flow in a case in which generation of the interruption event is not present (determination of NO) in Step ST4 (see FIG. 7).

As shown in FIG. 7, if generation of the interruption event is not present (determination of NO), in Step ST20 the undefined function state determination unit 205 determines whether a current state is the undefined function state or not. If the current state is the undefined function state (determination of YES), the processing advances to Step ST14. If the current state is not the undefined function state (determination of NO), the processing is terminated.

Although not described in the flow charts of FIGS. 7 and 8, the application activation determination unit 206 can determine whether or not activation of a predetermined function (application) is possible, and can activate the predetermined function only if activation thereof is determined to be possible.

As described above, in the cellular telephone device 1 of the present embodiment, in activation of an application based on the rotation operation of the rotary dial part 41, in the undefined function state, interruption processing such as an incoming call can be performed in preference to activation of the application that is a target for activation. In addition, the application that is a target for activation can be activated after completion of the interruption processing. A cellular telephone device having function operability that is more suitable for an actual usage mode by a user can thus be provided. In addition, even in a case in which the cellular telephone device 1 is provided with the rotary dial part 41, which is a physical operation means, a sense of fast operation can be provided in a natural way.

The embodiments of the present invention have been described above but the present invention is not limited to the aforementioned embodiments, and modifications are possible as appropriate.

For example, in the above embodiment, in a case in which a predetermined interruption event occurs in the undefined function state before the rotation of the rotary dial part is determined to have ended, the processing unit 70 performs predetermined interruption processing based on the interruption event, and activates a predetermined function based on the rotation after completion of the interruption process. However, the present invention is not limited thereto.

For example, in a case in which a predetermined interruption event is generated in the undefined function state before the rotation of the rotary dial part is determined to have ended, the processing unit 70 can perform predetermined interruption processing based on the interruption event after the rotation is determined to have ended, and can activate a predetermined function based on the rotation after completion of the interruption processing. Such processing is referred to as “processing at the end of rotation”. The processing at the end of rotation is preferable for interruption processing not requiring an early notification. For example, interruption processing of alarm ringing generally does not require early notification, and it is often appropriate to perform the interruption processing after the rotation of the rotary dial part 41 has ended, in the defined function state.

In the abovementioned example, the rotary dial part 41 is rotated in the standby state to activate an application; however, the present invention is not limited thereto. The rotary dial part 41 can be rotated to activate an application, from a state in which applications activated by the rotary dial part 41 or other applications are active.

The application that is a target for activation is not limited to the email application, and may also be the navigation system application, for example.

In the abovementioned embodiment, the interruption event is an incoming call; however, the interruption event is not limited thereto. The interruption event can also be an incoming email, an alarm ringing event, or reception of map update information for the navigation system. In a case in which a user moves while using the navigation system, the reception of map update information is often more important than activation of an application by operation (rotation) of the rotary dial part 41. Therefore, it is preferable to give priority to reception of map update information for the navigation system.

1. A mobile electronic device comprising: a body;
a rotary dial part that is rotatably attached to the body; and
a processing unit that, in a case in which start of rotation of the rotary dial part is detected, enters into an undefined function state of waiting for the rotation to end,
wherein the processing unit, in a case in which the rotation is determined to have ended in the undefined function state, exits the undefined function state and activates a corresponding function based on the rotation, and
in a case in which a predetermined event occurs in the undefined function state, performs a predetermined interruption process corresponding to the predetermined event before activating a predetermined function based on the rotation.

2. A mobile electronic device comprising: a body;
a rotary dial part that is rotatably attached to the body; and
a processing unit that: in a case in which start of rotation of the rotary dial part is detected, enters into an undefined function state of waiting for the rotation to end; and in a case in which the rotation is determined to have ended thereafter, activates a corresponding function based on the rotation,
wherein the processing unit, when a predetermined event occurs in the undefined function state before the rotation of the rotary dial part is determined to have ended, performs a predetermined interruption process based on the event after the rotation is determined to have ended, and activates a predetermined function based on the rotation after completion of the interruption process.

3. The mobile electronic device according to claim 1, wherein the processing unit determines that the rotation has ended by at least a predetermined time period elapsing after the rotation of the rotary dial part stops.

4. The mobile electronic device according to claim 1, wherein the processing unit, before activating the predetermined function, determines whether or not activation is possible and activates the predetermined function only if activation is determined to be possible.

5. The mobile electronic device according to claim 1, wherein the processing unit activates a function corresponding to an amount of rotation from a position at which the rotation of the rotary dial part begins to a position at which the rotation stops as the predetermined function.

6. The mobile electronic device according to claim 1 further comprising a radio communication unit that performs radio communication with an external device, wherein the event includes initiation of radio communication by the radio communication unit.

7. The mobile electronic device according to claim 6, wherein the event is an incoming call.

8. The mobile electronic device according to claim 2, wherein the processing unit determines that the rotation has ended by at least a predetermined time period elapsing after the rotation of the rotary dial part stops.

9. The mobile electronic device according to claim 2, wherein the processing unit, before activating the predetermined function, determines whether or not activation is possible and activates the predetermined function only if activation is determined to be possible.

10. The mobile electronic device according to claim 2, wherein the processing unit activates a function corresponding to an amount of rotation from a position at which the rotation of the rotary dial part begins to a position at which the rotation stops as the predetermined function.

11. The mobile electronic device according to claim 2 further comprising a radio communication unit that performs radio communication with an external device, wherein the event includes initiation of radio communication by the radio communication unit.

12. The mobile electronic device according to claim 11, wherein the event is an incoming call.

13. An application start control method for a mobile electronic device with a rotary dial part rotatably attached thereto, the method comprising:
a detection step of detecting rotation of the rotary dial part;
an end determination step of determining, after detection of beginning of the rotation, that the rotation has ended;
a first processing step of entering an undefined function state after detection of the beginning of the rotation until
determination that the rotation has ended;
a second processing step, upon determination that the rotation in the undefined function state has ended, of exiting the undefined function state and activating a predetermined function specified according to the rotation; and
a third processing step, in a case in which a predetermined event occurs in the undefined function state, of performing a predetermined interruption process corresponding to the predetermined event before activating the predetermined function.
